(19) United States
(12) Patent Application Publication
(10) Pub. No.: US 2026/0022808 A1
(43) Pub. Date: Jan. 22, 2026

(54) LUMINESCENT CABLE AND LIGHT-EMITTING DEVICE THEREFOR

(71) Applicant: Shanghai LanHao Jiangsu Electric Co., Ltd., Nantong City (CN)

(72) Inventors: Bingbing WANG, Nantong City (CN); Chunyan LIU, Nantong City (CN); Lei ZONG, Nantong City (CN)

(73) Assignee: Shanghai LanHao Jiangsu Electric Co., Ltd., Nantong City (CN)

(21) Appl. No.: 18/828,606

(22) Filed: Sep. 9, 2024

(30) Foreign Application Priority Data
Jul. 19, 2024 (CN) 202410970585.3

(51) Int. Cl. F21S 4/26; F21Y 103/10; F21Y 115/10

(52) U.S. Cl. CPC F21S 4/26; F21Y 2103/10; F21Y 2115/10

(57) ABSTRACT

Provided is a light-emitting device for a luminescent cable, relating to the technical field of luminescent cable. The light-emitting device for a luminescent cable includes a light strip capable of emitting light and a loose jacket layer. The loose jacket layer sleeves the light strip, the light strip is slidable relative to the loose jacket layer, and at least portion of the loose jacket layer is made of a light-transmitting material. A luminescent cable is further provided. When the luminescent cable is bent and stretched, the light strip is slidable in the loose jacket layer to adapt to the stretching and bending of the luminescent cable, thus preventing the light strip from being damaged due to excessive stretching force. Therefore, the durability of the light strip in the luminescent cable can be greatly improved, when the luminescent cable with the light strip is subjected to external forces such as tension, torsion, bending, impact force and the like, the light strip is not easy to be damaged, and thus the luminescent cable is durable in an open-pit mine and an underground mine with harsh environmental conditions.

### CROSS-REFERENCE TO RELATED APPLICATION

This patent application claims the benefit and priority of Chinese Patent Application No. 202410970585.3 filed with the China National Intellectual Property Administration on Jul. 19, 2024, the disclosure of which is incorporated by reference herein in its entirety as part of the present application.

### TECHNICAL FIELD

The present disclosure relates to the technical field of luminescent cable, and in particular to a light-emitting device for a luminescent cable, and the luminescent cable.

### BACKGROUND

There are many types of cables, which can normally be used when meeting power and signal transmission. However, in some special environments, such as open-pit mining, underground coal mines, port machinery and some places for nighttime operation, cables are often laid on the working road at will, and at night or in dark environment, as the operators in the field cannot see the position of cables, the cables are often crushed by engineering vehicles and collided with ores, resulting in cable damage and only few months of service life of the cables. Even if there is a certain cable maintenance technology, frequent maintenance and replacement of cables also bring great loss of production stoppage.

At present, the problem of the luminescence of the built-in LED strip in the luminescent cable has been basically solved in the market, and the LED strip can be driven to emit light by the energy collection element in the cable, such that night visual function of the cable can be achieved without external power supply. However, three shortcomings generally exist in these cables after investigation: 1. The light strip has low tensile strength. Because conductor wires of the light strip for powering the LED lamp beads are thin, the wires will be broken by a few kilograms of force, and once the light strips of the luminescent cable are connected in series, the whole cable will stop emitting light in a case that one place is disconnected, thus not playing a warning role. 2. The light strip is not resistant to bending. Similarly, because the conductor wire is thin, the thin conductor wire is easy to break or the core is broken due to the wear between the wire cores during the repeated bending of the cable. 3. The light strip is not resistant to extrusion/smashing. There is no good technical means outside the light strip to protect the light strip, and the cable, when crushed by vehicles or smashed by ores, cannot resist the strong extrusion force/impact force, which leads to core breakage.

### SUMMARY

The objective of the present disclosure is to provide a light-emitting device for a luminescent cable and the luminescent cable, so as to solve the problems in the prior art and prolong the service life of the device.

To achieve the objective above, the present disclosure employs the following technical solution:

A light-emitting device for a luminescent cable includes:
a light strip capable of emitting light; and
a loose jacket layer sleeving the light strip, where the light strip is slidable relative to the loose jacket layer, and at least portion of the loose jacket layer is made of a light-transmitting material.

In some embodiments, a gap is formed between the light strip and the loose jacket layer, such that the light strip is slidable freely in the loose jacket layer.

In some embodiments, the gap between the light strip and the loose jacket layer can be filled with a buffer medium or in vacuum setting. The filled buffer medium is one or more of gas, liquid, paste, and gel.

In some embodiments, the light strip is in a forms
that the light strip only includes an LED light bar; or
that the light strip includes an LED light bar, and a tight jacket layer wrapped around the LED light bar, where the tight jacket layer and the LED light bar are fixed relative to each other, the tight jacket layer and the LED light bar are slidably arranged in the loose jacket layer, and at least portion of the tight jacket layer is made of a light-transmitting material.

In some embodiments, the LED light bar includes multiple LED lamp beads, and cords for connecting the LED lamp beads and an energy collection element.

In some embodiments, the multiple LED lamp beads and the energy collection element are connected in series, connected in parallel, or connected in a series and parallel combination mode.

In some embodiments, the energy collection element is configured to provide energy required by LED lamp beads to emit light.

In some embodiments, the cross section of the loose jacket layer is circular, oval, rectangular, square, trapezoidal, fan-shaped, or irregular polygon.

The present disclosure further provides a luminescent cable, including a power wire core, a sheath layer, and the light-emitting device for a luminescent cable above. The power wire core and the light-emitting device for a luminescent cable are both bundled in the sheath layer, and at least portion of the sheath layer is made of a transparent material.

In some embodiments, the sheath layer includes an inner sheath, a reinforcing layer and an outer sheath nested in sequence from inside to outside.

Compared with the prior art, the present disclosure has the following technical effects:

By providing a loose jacket layer outside a light strip, the loose jacket layer and other cable cores in the luminescent cable as well as a sheath layer are fixed relative to each other, while the loose jacket layer and the light strip is slidable relative to each other. It is guaranteed that the luminescent cable is bent and stretched, the light strip is slidable in the loose jacket layer to adapt to the stretching and bending of the luminescent cable, thus preventing the light strip from being damaged due to excessive stretching force.

In addition, there is a buffer gap between the light strip and the loose jacket layer. When the luminescent cable is crushed by engineering equipment, the buffer gap can buffer an acting force exerted by the equipment, thus prevent the light strip from being damaged.

### BRIEF DESCRIPTION OF THE DRAWINGS

To describe the technical solutions of the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a schematic sectional diagram of a light-emitting device for a circular luminescent cable according to an embodiment of the present disclosure;

FIG. 2 is a three-dimensional diagram of a light-emitting device for a circular luminescent cable according to an embodiment of the present disclosure;

FIG. 3 is a schematic sectional diagram of a light-emitting device for a fan-shaped luminescent cable according to an embodiment of the present disclosure.

FIG. 4 is a structural schematic diagram of a luminescent cable according to an embodiment of the present disclosure.

In the drawings: 1, light-emitting device for luminescent cable; 11, LED bead; 12, cord; 13, tight jacket layer; 14, loose jacket layer; 2, power wire core; 3, grounding detection wire core; 4, ground wire core; 5, sheath layer.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by those of ordinary skill in the art based on the embodiments of the present disclosure without creative efforts shall fall within the scope of protection of the present disclosure.

In order to make the objectives, features and advantages of the present disclosure more clearly, the present disclosure is further described in detail below with reference to accompanying drawings and specific embodiments.

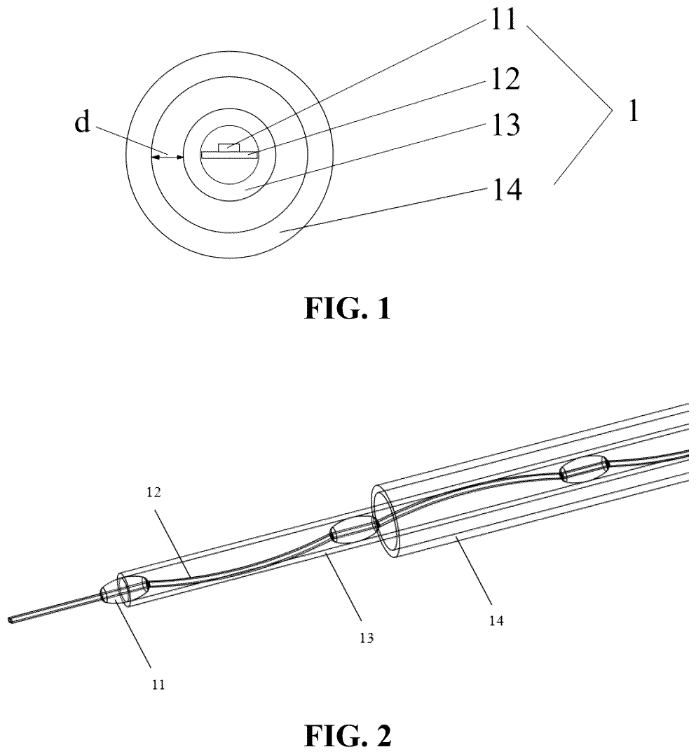

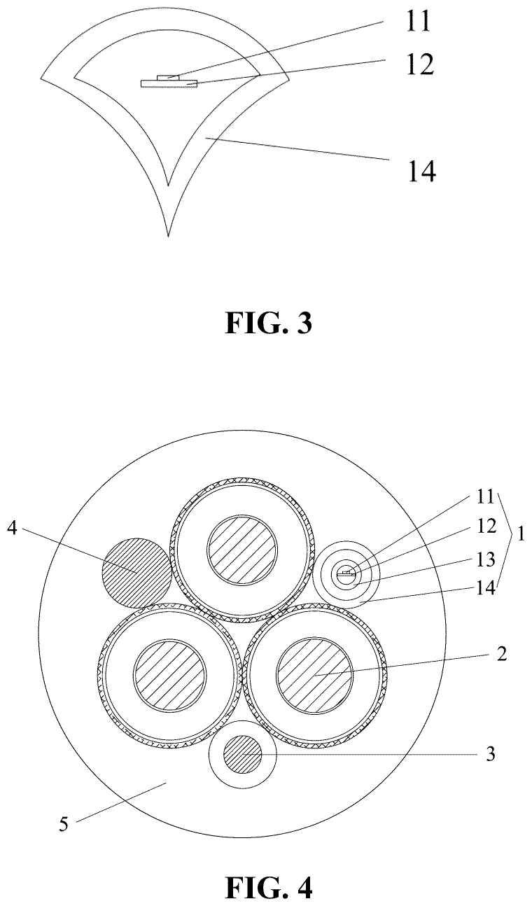

The present disclosure provides a light-emitting device 1 for a luminescent cable, as shown in FIGS. 1 to 3, including a light strip and a loose jacket layer 14. The light strip can emit light. The loose jacket layer 14 sleeves the light strip, and the light strip is slidable relative to the loose jacket layer 14, and at least portion of the loose jacket layer 14 is made of a light-transmitting material.

The light strip in the present disclosure may employ any luminescent light source in the prior art, e.g., a LED light bar.

By providing the loose jacket layer 14 outside the light strip, the loose jacket layer 14 and other cable cores in the luminescent cable as well as the sheath layer 5 are fixed relative to each other, while the loose jacket layer 14 and the light strip is slidable relative to each other. It is guaranteed that the luminescent cable is bent and stretched, the light strip is slidable in the loose jacket layer 14 to adapt to the stretching and bending of the luminescent cable, thus preventing the light strip from being damaged due to excessive stretching force.

It may be understood that when the luminescent cable is bent, the light strip may bend accordingly. As the light strip is slidable inside the luminescent cable, in order to prevent a bending portion of the light strip from being pulled by bending, the light strip on both sides of the bending portion may slide towards the bending portion by a small distance, which can prevent the light strip from being damaged by bending and pulling.

In some embodiments, there is a gap between the light strip and the loose jacket layer, such that the light strip is slidable freely in the loose jacket layer.

In consideration of another scenes, for example, due to the crushing damage of vehicles, in some embodiments, the gap between the light strip and the loose jacket layer 14 serves as a buffer gap.

In this embodiment, a buffer gap is provided between the light strip and the loose jacket layer 14. When the luminescent cable is crushed by an engineering equipment, the buffer gap can buffer an acting force exerted by the equipment, thus avoiding the damage of the light strip.

In some embodiments, the buffer gap is filled with a buffer medium or in vacuum setting. The filled buffer medium is one or more of gas, liquid, paste, and gel. For example, the buffer medium may be clear ointment. Whether to fill the medium or not, as long as the gap exists between the light strip and the loose jacket layer 14, the function of buffering external pressure can be achieved.

In some embodiments, the light strip is in a form:
that the light strip only includes an LED light bar; or
that the light strip includes an LED light bar, and a tight jacket layer 13 wrapped around the LED light bar, where the tight jacket layer 13 and the LED light bar are fixed relative to each other, the tight jacket layer 13 and the LED light bar are slidably arranged in the loose jacket layer 14, and at least portion of the tight jacket layer 13 is made of a light-transmitting material.

In a second embodiment of the present disclosure, due to the existence of the tight jacket layer 13, the tight jacket layer 13 can wrap around the LED light bar, thus playing a certain fixing role on portions of the LED light bar and reducing a friction force between the LED strip and the loose jacket layer 14. Therefore, the solution provided by the second embodiment has longer service life.

In some embodiments, the LED light bar includes multiple LED lamp beads 11, and cords 12 for connecting the LED lamp beads 11 and an energy collection element.

Each cord 12 is a flexible circuit board, or a soft conductor wire, but is not limited to the above flexible connecting structure. The LED lamp beads 11 are connected in series, in parallel, or in a series and parallel combination mode. The lamp beads may be in-line type, patch type or high-power type lamp beads, may be in a single row or multiple rows of patches, or single-color or multi-color, and can be used to increase the visual effect of the cable when used in the cable, thus increasing eye-catching thereof.

In other embodiments, the light-emitting device further includes an energy collection element connected in series or in parallel or in series and parallel with the LED lamp beads 11, and the energy collection element functions to provide the energy required for the lamp beads to emit light. Certainly, the present disclosure is not limited thereto, and any way of supplying power to LED light bar in the prior art can also be adopted.

The energy collection element is an element capable of providing energy for the lamp beads to emit light, such as an inductor, a capacitor, and a resistor. Specifically, any energy collection element capable of being applied to the LED light strip in the prior art is adopted.

In some embodiments, the tight jacket layer 13 is extruded and wrapped around the LED light bar by transparent LDPE (low-density polyethylene) tube extrusion, and is tightly attached to the LED light bar and cannot slide. Therefore, the existence of the transparent LDPE tight jacket layer 13 increases the tensile strength of the LED light bar and reduces the friction force between the LED light bar and the loose jacket layer 14. Then, the loose jacket layer 14 is extruded and wrapped around the transparent LDPE tight jacket layer 13, and transparent TPU (thermoplastic urethane) is used as a tube extrusion material of the loose jacket layer 14. In this embodiment, the outer diameter of each of the LED lamp bead 11 and the cords 12 is about 3-5 mm, the extruded and wrapped LDPE has a thickness of about 0.5 mm, an extruded and wrapped outer diameter is about 4-5 mm, a gap d=2 mm is provided between the tight jacket layer 13 and the loose jacket layer 14, a TPU thickness of the loose jacket layer 14 is 1.5 mm, and after the loose jacket layer 14 is extruded and wrapped, an outer diameter of the whole light-emitting device 1 for the luminescent cable is about 10 mm.

In other embodiments, light-transmitting materials, such as HDPE (high-density polyethylene), MDPE (medium-density polyethylene), LLDPE (linear low-density polyethylene), PP (polypropylene), PET (polyethylene terephthalate), PC (polycarbonate), PVC (polyvinyl chloride), FEP (fluorinated ethylene propylene), PTFE (polytetrafluoroethylene), EVA (ethyl vinyl acetate), TPU, TPE (thermoplastic elastomer), nylon and silicone rubber, can be used as the material of the tight jacket layer 13. In some embodiments, there is no need to provide the tight jacket layer 13 outside the LED lamp beads 11 and the cords 12.

In other embodiments, light-transmitting materials, such as LDPE, HDPE, MDPE, LLDPE, PP, PET, PC, PVC, FEP, PTFE, EVA, TPE, nylon and silicone rubber, can be used as a material of the loose jacket layer 14. The cross section of the loose jacket layer 14 may be oval, rectangular, square, fan-shaped, trapezoidal, or irregular polygon.

In conclusion, in some embodiments, the light-emitting device 1 for a luminescent cable provided by the present disclosure includes LED lamp beads 11, an energy collection element (an element capable of providing energy for the lamp beads to emit light, e.g., an inductor, a capacitor and a resistor), cords 12 for connecting the lamp beads and the energy collection element, a tight sheath layer 13 and a loose sheath layer 14 which are wrapped around the lamp beads, the energy collection element and the connecting cords 12. In order to facilitate understanding, the structure of the light-emitting device 1 for the luminescent cable can be divided into three portions. The first portion is a luminescent working portion, including the LED lamp beads 11, the energy collection element, and the cords 12 for connecting the lamp beads and the energy collection element. The first portion at least includes the LED lamp beads 11 and the connecting cords 12, and the energy collection element is required only when the energy required by the light strip for luminescence needs to be completely collected by itself. The second portion is the tight jacket layer 13, which is a transparent polymer material layer wrapped around the first portion. The second portion is not necessary in the structure, and if the second portion exists, it is tightly wrapped around the first portion, and the first portion and the second portion do not slide relative to each other. The third portion is the loose jacket layer 14, which is a transparent polymer material layer wrapped around the second portion or directly wrapped around the first portion. The third portion is necessary, and there is an enough gap between the third portion and units therein, such that the third portion and the units therein can slide easily and freely relative to each other.

The present disclosure further provides a luminescent cable, as shown in FIG. 4, including a power wire core 2, a sheath layer 5, and the light-emitting device 1 for a luminescent cable above. The power wire core 2 and the light-emitting device 1 for a luminescent cable are all bundled in the sheath layer 5, and at least portion of the sheath layer 5 is made of a transparent material.

The power wire core 2 and the light-emitting device 1 for the luminescent cable form a cable core, and which wire cores are specifically included in the cable core depends on the functional requirements of the cable, but the cable core at least includes the power wire core 2 and the light-emitting device 1 for the luminescent cable.

It may be understood that in some embodiments, the luminescent cable further includes a grounding detection wire core 3, and a ground wire core 4. The power wire core 2, the grounding detection wire core 3, the ground wire core 4 and the light-emitting device 1 for the luminescent cable are bundled in the sheath layer 5.

The above bundling method is usually twisting. Certainly, in some embodiments, other bundling methods may be adopted instead of twisting, and the present disclosure is not limited to this.

In some embodiments, the sheath layer 5 includes an inner sheath, a reinforcing layer, and an outer sheath which are nested in turn from inside to outside.

In some embodiments, three power wire cores 2 are attached to each other in pairs and form three gaps at the outside. The light-emitting device 1 for the luminescent cable, the grounding detection wire core 3 and the ground wire core 4 are arranged in the three gaps, respectively. The light-emitting device 1 for the luminescent cable has a circular shape in fit with the gap.

In some embodiments, the sheath layer 5 is made of a light-transmitting polymer material, e.g., a TPU material, which ensures the visualization of the light-emitting device 1 for the luminescent cable, increases the visualization effect of the cable, such that the cable can be clearly seen at night and in dark environment, and is prevented from being crushed and damaged by surrounding engineering vehicles and equipment, the safety performance of the cable is improved.

In some embodiments, the sheath layer 5 includes an inner sheath, a reinforcing layer, and an outer sheath which are nested in turn from inside to outside. The reinforcing layer is a woven reinforcing layer, and the inner sheath and the outer sheath are made of the material of the sheath layer 5 in the above embodiment.

Therefore, the durability of the light strip in the luminescent cable can be greatly improved, such that when the luminescent cable with the light strip is subjected to external forces such as tension, torsion, bending, impact force and the like, the light strip is not easy to be damaged, and thus the luminescent cable is durable in an open-pit mine and an underground mine with harsh environmental conditions.

Specific examples are used herein for illustration of the principles and embodiments of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A light-emitting device for a luminescent cable, comprising:
a light strip capable of emitting light; and
a loose jacket layer sleeving the light strip, wherein the light strip is slidable relative to the loose jacket layer, and at least portion of the loose jacket layer is made of a light-transmitting material;
wherein, the light strip comprises
an LED light bar, and
a tight jacket layer slidably arranged in the loose jacket layer;
wherein the tight jacket layer is extruded and wrapped around the LED light bar, and is tightly attached to the LED light bar; and
a gap is formed between the tight jacket layer and the loose jacket layer, such that the light strip is slidable freely in the loose jacket layer.

2. (canceled)

3. The light-emitting device for a luminescent cable according to claim 1, wherein the gap between the light strip and the loose jacket layer is filled with a buffer medium or in a vacuum setting, and the buffer medium filled is one or more of gas, liquid, paste, and gel.

4. The light-emitting device for a luminescent cable according to claim 1, wherein at least a portion of the tight jacket layer is made of a light-transmitting material.

5. The light-emitting device for a luminescent cable according to claim 4, wherein the LED light bar comprises a plurality of LED lamp beads, and cords for connecting the plurality of LED lamp beads and an energy collection element.

6. The light-emitting device for a luminescent cable according to claim 5, wherein the plurality of LED lamp beads and the energy collection element are connected in series, in parallel, or in a series and parallel combination mode.

7. The light-emitting device for a luminescent cable according to claim 5, wherein the energy collection element is configured to provide energy for the plurality of LED lamp beads to emit light.

8. The light-emitting device for a luminescent cable according to claim 1, wherein a cross section of the loose jacket layer is circular, oval, rectangular, square, trapezoidal, fan-shaped, or irregular polygon.

9. A luminescent cable, comprising a power wire core, a sheath layer, and a light-emitting device for the luminescent cable, wherein the power wire core and the light-emitting device are both bundled in the sheath layer, and at least portion of the sheath layer is made of a transparent material;
and wherein the light-emitting device for the luminescent cable comprises:
a light strip capable of emitting light; and
a loose jacket layer sleeving the light strip, wherein the light strip is slidable relative to the loose jacket layer, and at least portion of the loose jacket layer is made of a light-transmitting material;
wherein, the light strip comprises
an LED light bar, and
a tight jacket layer slidably arranged in the loose jacket layer; and
wherein the tight jacket layer is extruded and wrapped around the LED light bar, and is tightly attached to the LED light bar; and
a gap is formed between the tight jacket layer and the loose jacket layer, such that the light strip is slidable freely in the loose jacket layer.

10. The luminescent cable according to claim 9, wherein the sheath layer comprises an inner sheath, a reinforcing layer and an outer sheath nested in sequence from inside to outside.

11. (canceled)

12. The luminescent cable according to claim 9, wherein the gap between the light strip and the loose jacket layer is filled with a buffer medium or in a vacuum setting, and the buffer medium filled is one or more of gas, liquid, paste, and gel.

13. The luminescent cable according to claim 9, wherein at least portion of the tight jacket layer is made of a light-transmitting material.

14. The luminescent cable according to claim 13, wherein the LED light bar comprises a plurality of LED lamp beads, and cords for connecting the plurality of LED lamp beads and an energy collection element.

15. The luminescent cable according to claim 14, wherein the plurality of LED lamp beads and the energy collection element are connected in series, in parallel, or in a series and parallel combination mode.

16. The luminescent cable according to claim 14, wherein the energy collection element is configured to provide energy for the plurality of LED lamp beads to emit light.

17. The luminescent cable according to claim 9, wherein a cross section of the loose jacket layer is circular, oval, rectangular, square, trapezoidal, fan-shaped, or irregular polygon.

18. The luminescent cable according to claim 9, wherein the sheath layer comprises an inner sheath, a reinforcing layer and an outer sheath nested in sequence from inside to outside.

19. The luminescent cable according to claim 12, wherein the sheath layer comprises an inner sheath, a reinforcing layer and an outer sheath nested in sequence from inside to outside.

20. The luminescent cable according to claim 13, wherein the sheath layer comprises an inner sheath, a reinforcing layer and an outer sheath nested in sequence from inside to outside.
